(19) United States
(12) Patent Application Publication
(10) Pub. No.: US 2015/0257582 A1
(43) Pub. Date: Sep. 17, 2015

(54) REFILLABLE BEVERAGE BREWER SYSTEM

(71) Applicant: TOUCH COFFEE & BEVERAGES, LLC, City of Industry, CA (US)

(72) Inventor: Sung I. Oh, West Covina, CA (US)

(21) Appl. No.: 14/645,166

(22) Filed: Mar. 11, 2015

Related U.S. Application Data
(60) Provisional application No. 61/967,140, filed on Mar. 11, 2014.
(60) Provisional application No. 61/995,321, filed on Apr. 8, 2014.

(51) Int. Cl. A47J 31/40

(52) U.S. Cl. CPC A47J 31/407

(57) ABSTRACT

A brewer system is adapted to brew a beverage utilizing a cartridge packed with beverage grind such as coffee, tea, milk, and the like to make one cup of beverage, and multiple cups of beverage utilizing a refillable cup utilizing the same brewer system.

### RELATED APPLICATION

This application claims priority to two U.S. provisional application numbers: (1) 61/967,140 filed Mar. 11, 2014; and (2) 61/995,321 filed Apr. 08, 2014, which are all hereby incorporated by reference.

### BACKGROUND OF THE INVENTION

1. Field of the Invention

This invention is directed a beverage brewing system capable of brewing one cup of beverage or multiple cups of bever into a carafe.

2. Background

Brewing coffee through a single-serve cartridge has become popular for its convenience and a variety of coffee flavors that are offered. Single-serve cartridges are packed with pre-measured coffee grind that can be inserted into a brewer to inject heated water into the cartridge to brew a cup of coffee. While single-serve cartridges are convenient to brew one cup of coffee quickly, it can be inconvenient and time consuming to brew multiple cups of coffee one after another during those occasions when there is a family gathering or with multiple house guests desiring a cup of coffee. In such occasions, brewing a pot of coffee or multiple cups of coffee into a carafe would be more convenient, but to do so, a separate traditional drip brewer may be needed. Having a single-serve brewing system and a traditional drip coffee brewer can take up extra kitchen counter space, which may be undesirable for some homeowners. Accordingly, there is a need to brew a one cup as well as several cups of coffee with one brewing system.

### INVENTION SUMMARY

A brewing system is adapted to brew a beverage utilizing a cartridge packed with beverage grind such as coffee, tea, milk, and the like to make one cup of beverage, and multiple cups of beverage utilizing a refillable cup with the same brewer. The brewing system includes a brewer having a well adapted to receive a holder and a refillable cup. The holder is adapted to pierce a hole through a single-serve beverage cartridge packed with premeasured amount of beverage grind to brew one cup of beverage. The holder can be removed for cleaning

The refillable cup includes a cap and a container. With the cap removed, the container can be packed with substantially more beverage grind, such as at least 200% more, than the beverage grind packed into a single-serve beverage cartridge to brew multiple cups of beverage. The holder can be removed, and the refillable cup can be inserted into the well. The refillable cup is configured to substantially fill the well to maximize the internal spacing to pack as much beverage grind as possible. The cap may have a guard to prevent outer debris from entering the container once the cap is closed to the container. The cap may also have an elongated porous cone to provide a path for heated water to pass deep into the beverage grind inside the container to evenly extract the beverage from the grind in the bottom.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a perspective view of an internal main frame of a brewer adapted to receive a holder.

FIG. 2 is a cross-sectional view of the main frame along the line 2-2 show in FIG. 1.

FIG. 3 shows the main frame of FIG. 3 with the holder removed.

FIG. 4 shows another perspective view of the main frame.

FIG. 5 shows a perspective view of a refillable cup.

FIG. 6 shows the refillable cup without the mesh shown in FIG. 5.

FIG. 7 shows a perspective view of the cap.

FIG. 8 shows the cap with an elongated porous cone.

FIG. 9 shows a perspective view of the refillable cup without the mesh.

FIG. 10 shows a cross sectional view of the refillable cup inserted into the brewer.

FIG. 11 shows a pouch packed with premeasured amount of beverage that can be sealed within a bag.

FIG. 12 shows a carafe placed underneath the refillable cup to hold large amount of beverage.

### DETAILED DESCRIPTION OF THE INVENTION

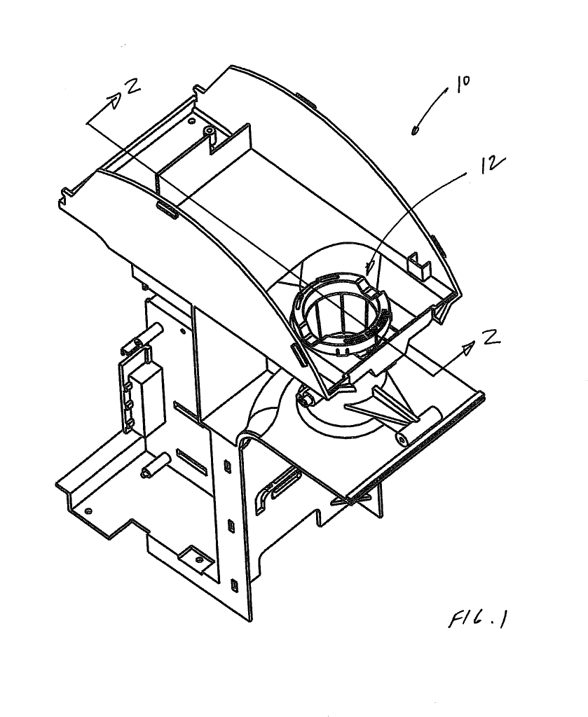

FIG. 1 shows a perspective view of an internal main frame 10 of a brewer adapted to receive a holder 12. The holder 12 may be adapted to receive different size single-serve cups in a manner generally described in U.S. patent application Ser. No. 13/925,595 and Ser. No. 13/925,604, both of which were filed on Jun. 24, 2014, which are both hereby incorporated by references. The different size single-serve cups may be adapted to pack up to about 20 grams of grind coffee depending the roast. By way of background, as coffee beans are roasted or backed for a longer period of time, the coffee beans loose more moisture and becomes darker and weigh less, and vice versa. With about 20 grams of coffee, it may be enough to brew 14 oz to 18 oz cup of coffee but not much more without making the coffee taste too weak.

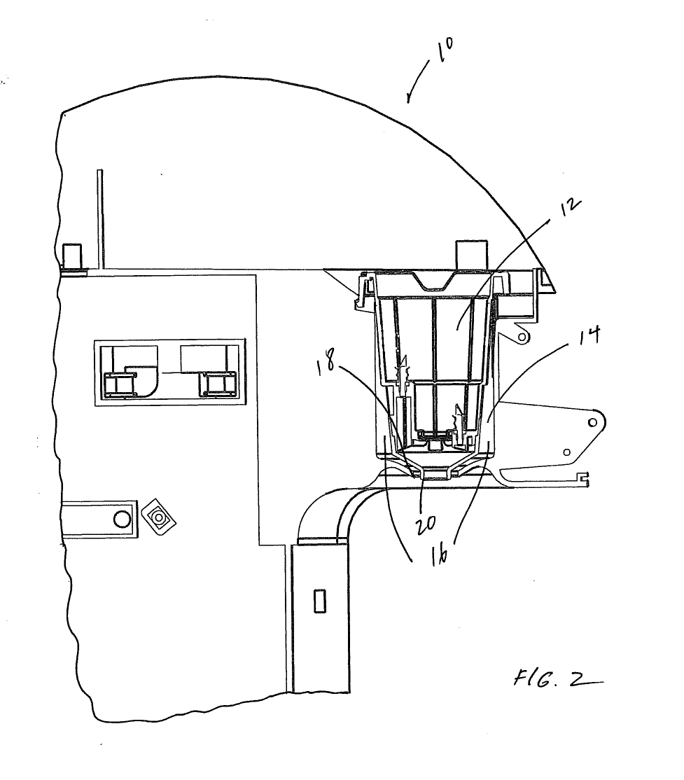

FIG. 2 is a cross-sectional view of the main frame 10 along the line 2-2 show in FIG. 1. The main frame 10 may have a well 14 adapted to receive the holder 12. The holder 12 may be sized such that a gap 16 may be formed between the well 14 and the holder 12. The holder may be removed from the well for cleaning The well may have an opening 18 to allow the funnel 20 of the holder 12 to protrude therethrough to allow the beverage to drain from the funnel 20 and into a mug.

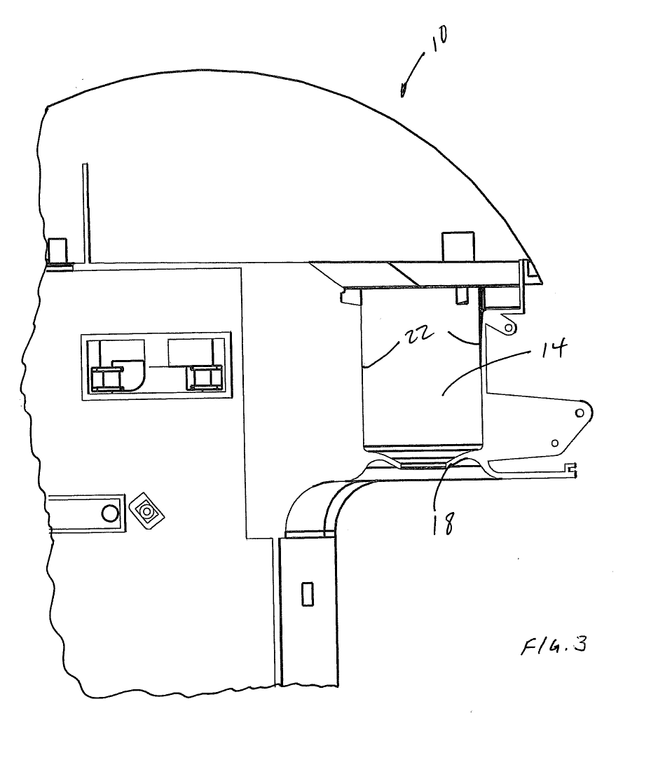

FIG. 3 shows the main frame 10 of FIG. 3 with the holder removed. The well 14 may have a side wall 22 in the shape of a round bore with the opening 18 at the bottom for draining the beverage, as also shown in the perspective view of FIG. 4.

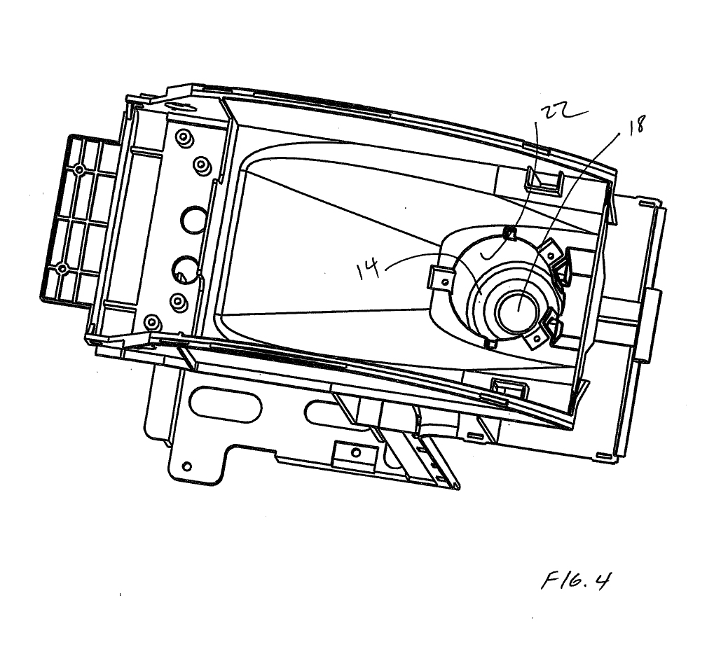

FIG. 5 shows a perspective view of a refillable cup 22 adapted to insert into the well 14 of the main frame 10. The refillable cup 22 may have a cap 24 and a container 26 adapted to couple with the cap 24. The cap 24 may have an opening 28 adapted to receive the inlet needle from the brewer to inject heated water into the refillable cup 22. The container 26 may have a frame 30 coupled to one or more meshes sized to substantially hold the beverage grind within the container yet allow the liquid beverage to pass therethrough. The frame 30 may have ribs 34 that provide structural support to the mesh 32 and divide the mesh 32 into several portions 36. The pore size of the mesh may be varied depending on the application such as whether coffee or tea is being brewed with the refillable cup. The mesh may be made from a variety of materials such as metal, paper, synthetic fiber and any other materials known to one skilled in the art. The porous openings may be also formed into the container.

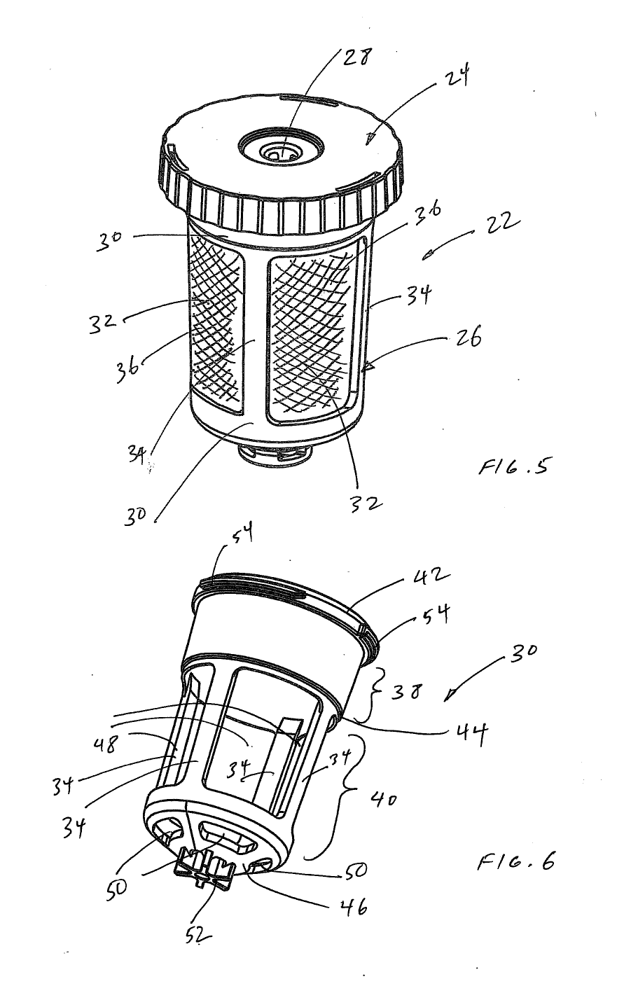

FIG. 6 shows the frame 30 without the mesh 32 shown in FIG. 5. The frame 30 may be divided into a serval portions such as a first portion 38 and a second portion 40. The first portion 38 may be generally defined by a space between an upper rim 42 and an intermediate ring 44, and the second portion 40 may be generally defined by a space between the intermediate ring 44 and a base 46. The first portion 38 may be formed of solid side wall so that it is impermeable to liquid. The second portion 40 may have several windows 48 defined by the ribs 34 extending between the intermediate ring 44 and the base 46. As discussed above in reference to FIG. 5, the mesh 32 may be integrated or coupled to the second portion 40 of the frame to retain the beverage grind within the container yet allow the liquid beverage to pass therethrough.

The base 46 of the frame 30 may have smaller windows 50 adapted to couple with mesh as well to allow the beverage to pass therethrough while holding the beverage grind within the container. The base 46 may have a tip 52 adapted to drain the beverage more smoothly with nominal splattering. The upper rim 42 of the frame 30 may have one or more extending tabs 54 adapted to engage with the cap 24 to removably seal the cap to the container 22.

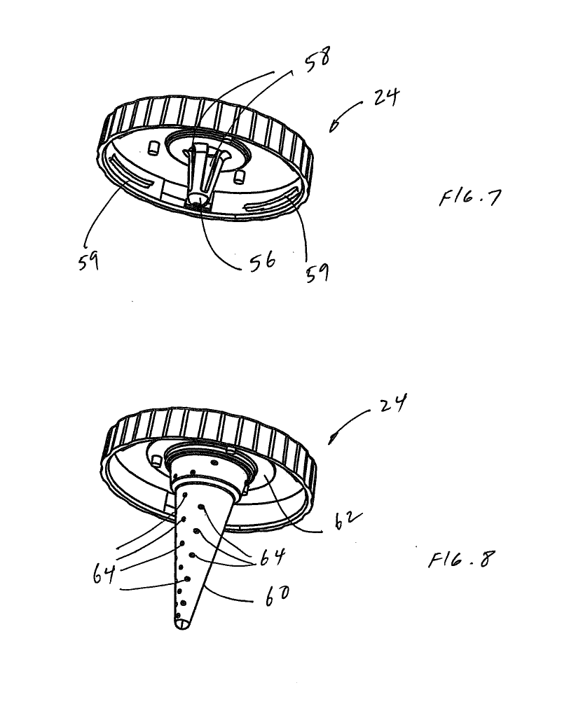

FIG. 7 shows a perspective view of the cap 24 having a guard 56 extending from the opening 28 to substantially prevent outer debris from passing through the opening 28 and into the container 22. The guard 56 may have slotted openings 58 adapted to release the heated water from the inlet needle and into the container 22. The cap 24 may have a protruding tabs 59 adapted to engage with the extending tabs 54 from the frame 30 to releaseaby seal the cap 24 onto the container 22.

FIG. 8 shows that the cap 24 may also include an elongated cone 60 adapted to penetrate into the space defined by the second space 40 to deliver heated water deep into the beverage grind located in the second portion 40 of container to evenly wash or extract the flavors from the beverage grind located in the first and second portions 38 and 40. The elongated cone 60 may have a base 62 adapted to enclose the guard 56 and couple to the cap 24. The elongated con 60 may have a plurality of porous holes 64 to allow the heated water from the inlet needle to pass through the porous holes 64 along the longitudinal axis of the elongated cone 60.

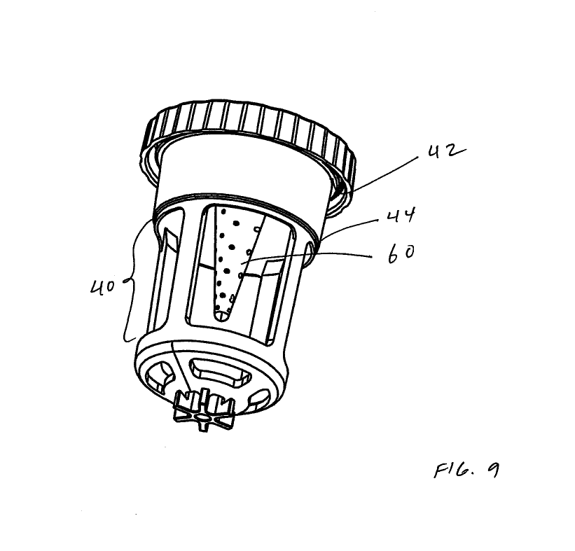

FIG. 9 shows a perspective view of the refillable cup 22 without the mesh 32. With the cap 24 releaseably coupled to the container 22, the elongated cone 60 may penetrate deep into the second portion 40 of the frame 30 so that heated water may be delivered to the beverage grind located deep inside the second portion 40 to extract the flavors from such grinds. The refillable cup 22 may brew a variety of beverages such as coffee and tea. For coffee, depending on the darkness of the roast, the refillable cup may be packed with coffee grind slightly above the intermediate ring 44, which may be between 20 to 30 grams of coffee, which may be enough to brew one cup of 12 to 20 oz cup of coffee depending on how strong or mild the coffee drinker desires to drink. To brew multiple cups at once, coffee grind may be filled up to the upper rim 42, which may be between 25 to 45 grams of coffee, which may be enough to fill a carafe holding 24 oz to 35 oz of coffee depending on how strong or mild the coffee drinker desires to drink. For instance, the refillable cup may be configured to hold at least 25 grams of grind coffee; or at least 30 grams of grind coffee; or at least 35 grams of grind coffee; or at least 40 grams of grind coffee.

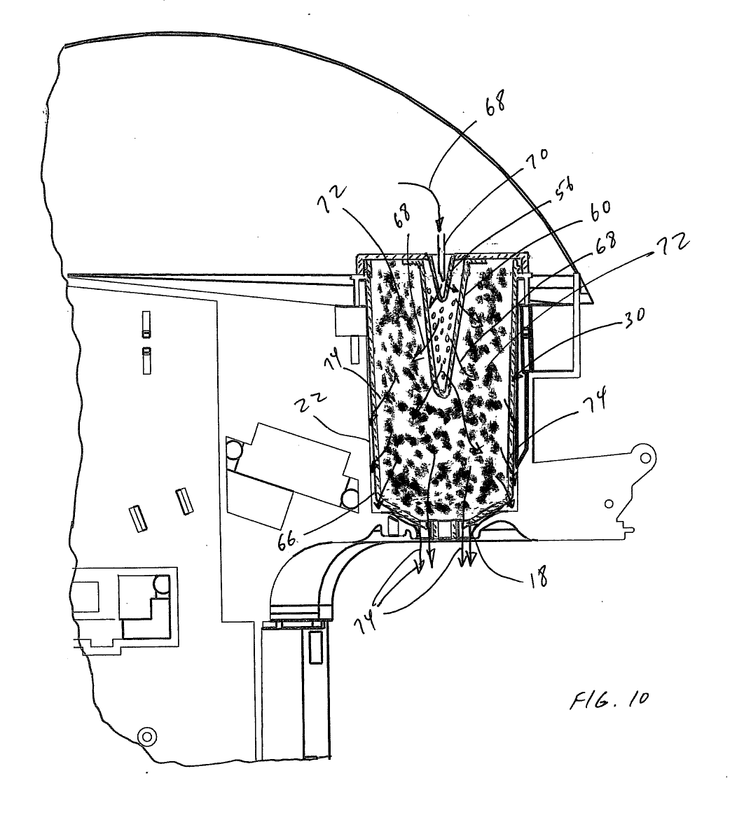

FIG. 10 shows a cross sectional view of the refillable cup 22 inserted into the well 14. The frame 30 of the refillable cup 22 may be sized to substantially fill the space within the well 14 such that a nominal gap 66 may be formed between the refillable cup 22 and the side wall 22 of the well to allow the beverage to drain down to the bottom opening 18. The nominal gap may be less than 3.0 mm. Heated water as indicated by the direction arrow 68 may be injected through the inlet needle 70 such that the heated water passes through the guard 56 and the elongated cone 60 through the porous holes 64. As the heated water passes through the beverage grind 72 as represented as dark dots, the beverage is formed, as represented by the direction arrows 74, and passes through the mesh and drains down the gap 66 and further down through the opening 18. With the refillable cup 22 substantially filling the well 14, the amount of beverage grind that can be packed into the refillable cup 22 may be maximized to brew stronger and bigger pot of coffee. With the refillable cup 22, a coffee drinker may grind his or her favorite coffee and brew enough coffee to fill a carafe capable of holding 24 to 35 oz of coffee, for example, utilizing the same brewer capable of brewing single-serve capsules by removing the holder 12 and inserting the refillable cup 22 in its place.

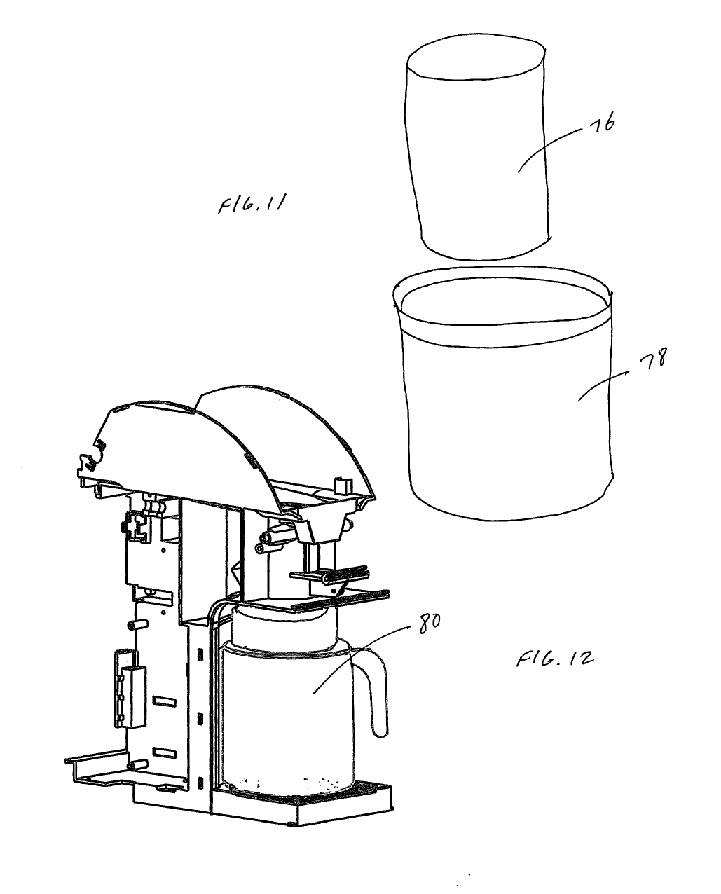

FIG. 11 shows a pouch 76 packed with premeasured amount of beverage grind such as coffee grind where the pouch 76 may be sized to fit inside the container 22. The pouch 76 may be sealed air tight into a sealed bag 78. This way, a coffee drinker may remove the pouch 76 from the sealed bag 78 and insert the pouch into the container 22 for convenience instead of having to grind the coffee.

FIG. 12 shows a carafe 80 placed underneath the opening 18 of the well 14 to hold the beverage draining from the refillable cup 22.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A method of brewing a single-serve beverage cartridge and a refillable cup from a same brewer having a well configured to house a holder adapted to pierce a hole through the single-serve beverage cartridge to drain the beverage therefrom through the hole and drain through an opening defining the well, the method comprising:
removing the holder from the well;
inserting the refillable cup into the well such that a gap formed between the refillable cup and the well is minimized;
injecting heated water into the refillable cup to brew a beverage;
draining the beverage within the refillable cup through a side wall of the refillable cup; and
passing the beverage through the gap and draining through the opening defining the well.

2. A method according to claim 1, further including:
packing at least 25 grams of grind coffee into the refillable cup.

3. A method according to claim 1, further including:
packing at least 30 grams of grind coffee into the refillable cup.

4. A method according to claim 1, further including:
packing at least 35 grams of grind coffee into the refillable cup.

5. A method according to claim 1, further including:
packing at least 40 grams of grind coffee into the refillable cup.

6. A method according to claim 1, further including:
passing heated water deep into the refillable cup.

7. A single-serve beverage brewing system configured to brew one cup or a multiple cups of beverage, the system comprising:
a holder configured to pierce a hole into a single-serve beverage cartridge;
a brewer having a well adapted to receive the holder and inject hot liquid into the single-serve beverage cartridge, the well defining an opening; and
a refillable cup having a cap and a container, the container configured to insert into the well and substantially fill the well and form a gap between the container and the well that is nominal, the container divided into a first portion and a second portion, the first portion substantially impermeable to liquid and the second portion permeable to liquid such that beverage formed within the container passes through the second portion and drain through the gap between the container and the well and through the opening.

8. An apparatus according to claim 7, where the container is sized to hold at least 25 grams of grind coffee.

9. An apparatus according to claim 7, where the container is sized to hold at least 30 grams of grind coffee.

10. An apparatus according to claim 7, where the container is sized to hold at least 35 grams of grind coffee.

11. An apparatus according to claim 7, where the container is sized to hold at least 40 grams of grind coffee.

12. An apparatus according to claim 7, where the cap has a guard and an elongated porous cone over the guard.

13. An apparatus according to claim 12, where the elongated porous cone protrudes down so that a distal end of the elongated porous cone extends into the second portion of the container when the cap is assembled to the container.
